(19) United States
(12) Patent Application Publication
(10) Pub. No.: US 2014/0149392 A1
(43) Pub. Date: May 29, 2014

(54) UNIFIED SEARCH RESULT SERVICE AND CACHE UPDATE

(71) Applicant: MICROSOFT CORPORATION, Redmond, WA (US)

(72) Inventors: Junhua Wang, Sammamish, WA (US); Yanbiao Zhao, Redmond, WA (US); Dong Yan, Sammamish, WA (US); Chuang Gu, Bellevue, WA (US)

(73) Assignee: MICROSOFT CORPORATION, Redmond, WA (US)

(21) Appl. No.: 13/687,954

(22) Filed: Nov. 28, 2012

(51) Int. Cl. G06F 17/30

(52) U.S. Cl. CPC G06F 17/30011
USPC 707/722

(57) ABSTRACT

A unified fresh search result serving approach that employs instant cache update. The instant result cache update efficiently updates the cache server instantly with the latest version of results in time. A unified cache service stores all related documents; thus, all information of a web document is saved on the same server to easily merge all the related information of web documents when generating captions for that document. Any update to web document content is immediately available in the result.

### BACKGROUND

Search result serving represents a significant part of a web search user experience. Traditional search systems provide results served from a cached copy of webpages on a cache server. These systems are adequate for those web documents which do not change frequently (e.g., a few days). However, other webpages, such as news, a freely-editable information source of webpages, etc., can change in a very short time. To meet a requirement of instant freshness, the traditional solution has to employ a dedicated freshness service other than the usual web service to provide results for just these specific set of web documents.

Issues with the traditional solution with a dedicated fresh service include optimization only for freshness and narrowly-defined tuning. Using a fresh result service only optimized for freshness, the documents stored there do not include all accumulated information on the webpages, which is available on typical web service. Results have to be merged from two parts to get the final result, which is inefficient. Moreover, this kind of fresh result service is only tuned to match related new documents, and only documents returned from the fresh service receive freshened results. Other documents from the typical web service still receive old results. Because of these two issues, the traditional system is neither efficient nor flexible.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is unified fresh search result serving approach that employs instant cache update. The unified results service is a cost-effective way to provide fresh caption service for all web documents. The instant result cache update efficiently updates the cache server instantly with the latest version of results in time.

The unified cache service stores all related documents; thus, all information of a web document is saved on the same server to easily merge all the related information of web documents when generating captions for that document. Any update to web document content is immediately available in the result.

With respect to instant results cache update, in the cache service, in addition to the web document result, the version of the web document which was used to generate the result is also stored. For each query, if the result is found from the cache, the web search service returns the cached content immediately. Afterward, the cache service sends a refresh request to the result service. The request includes all document identifiers and the versions of the document. The result service checks the latest version in the store against the versions in the request. If the results service does not find a newer version of a document, the service returns nothing for that document; otherwise, if a newer version is available, the results service regenerates the result for the document and returns it so the cache gets a refreshed version for that document. The next query request for that document returns the refreshed result in the query response.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system for fresh results serving.

FIG. 3 illustrates a method in accordance with the disclosed architecture.

FIG. 4 illustrates an alternative method in accordance with the disclosed architecture.

FIG. 5 illustrates illustrated a block diagram of a computing system that executes unified fresh result serving using instant result cache updating in accordance with the disclosed architecture.

### DETAILED DESCRIPTION

To improve efficiency in web search systems, the final search result can be cached in a cache service so there is no need to repeatedly search the whole web index for a redundant query. The cached result includes the result generated. With respect to result freshness, however, although a document has been updated in the store, the web search service may still return old results in the cache service.

The disclosed instant result cache update architecture guarantees the freshness of results in a cache server by instantly updating the cache server with the latest version of the results in realtime. This technique improves performance in result responses to redundant (repeatedly the same) queries.

Rather than using different servers to store results for different tiers, the disclosed architecture stores all related documents. All information of a document is saved on the same server, making it easy to merge all the related information of documents when generating results for that document. Any update to document content is immediately made available in the result.

The overall latency will not be affected, since the user need not wait for the refresh response for a refresh request served from the result service. Numerous refresh requests from the cache service are handled by returning nothing from a search results service. This may only cost a simple lookup and version comparison. This unified approach obviates the need to hard code support for some special domains—all domains will automatically obtain from the fresh results.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

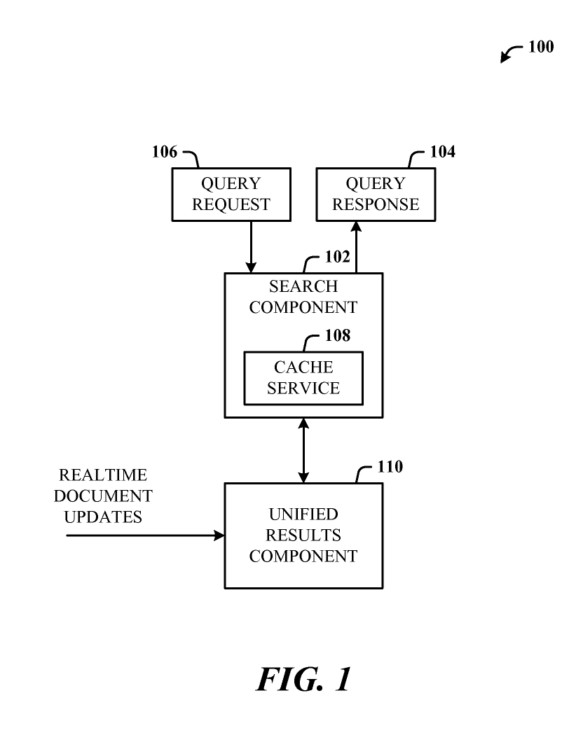

FIG. 1 illustrates a system 100 in accordance with the disclosed architecture. The system 100 can include a search component 102 that serves a search result as a query response 104 to a query request 106. The search component 102 includes a cache service 108 from which the search result is obtained. A unified results component 110 stores and services all related search documents and updates the cache service 108 on an as-needed basis.

The unified results component 110 receives realtime updates to the stored search documents. The search component 102 sends a search result refresh request to the unified results component 110. The unified results component 110 sends a cache refresh response to the search component 102. The cache service 108 stores the web document and document version information of the web document. The search component 102 returns the search result from the cache service 108 when the search result is in the cache service 108. The cache service 108 sends a refresh request to the unified results component 110. The refresh request specifies document identifiers and document versions. The unified results component 110 regenerates a search result of a search document in response to receiving an updated version of the search document, and sends the updated version of the search document to the cache service 108.

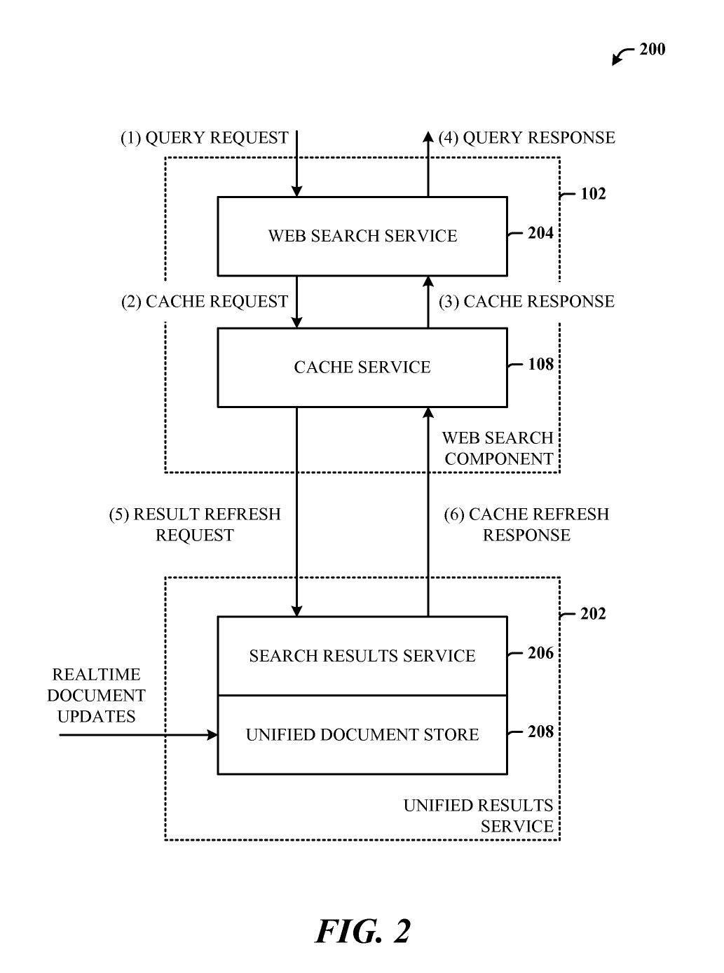

FIG. 2 illustrates an alternative system 200 for fresh results serving. The system 200 comprises the web search component 102 and a unified results service 202 (similar to the unified results component 110). The web search component 102 includes a web search service 204 and the cache service 108, and the unified results service 202 includes a search result service 206 and a unified document store 208.

The web search service 204 receives a query request, at (1), and seeks to provide a query response, at (4). In the cache service 108 stores the document search result (also referred to as a caption) and the version of the document which was used to generate the caption. For every query request, if the search result is found in the cache service 108, as requested by the web search service 204 in a cache request, at (2), the web search service 204 immediately returns the cached search result (content) from the cache service 108 in a cache response, at (3).

Thereafter, the cache service 108 sends a result refresh request, at (5), to the search result service 206. The result refresh request includes all document identifiers and the version information of the document to be refreshed. The search result service 206 checks the latest version information of the document in the unified document store 208 against the version information in the refresh request. If the search result service 206 does not find a newer version of the document in the document store 208, the search result service 206 returns no data for that document, in the cache refresh response, at (6); otherwise, if a newer version of the document is available in the unified document store 208, the search result service 206 regenerates the result for the document and returns the regenerated result in the cache refresh response to the cache service 108 so that the cache service 108 now stores a refreshed version for that document. On the next query request to the web search service 204 for that document, the refreshed result stored in the cache service 108 will be obtained by the web search service 204 from the cache service 108 and returned in the query response.

The unified results service 202 receives realtime document updates for documents in the unified document store 208. These updates can be communicated asynchronously to the unified document store 208 from an update source (not shown), and independently to any operation between the unified results service 202 and the web search component 102. Additionally, the interchange between the web search service 204 and the cache service 108 can be implemented according to push, poll and on-demand technologies. Similarly, the communications between the web search component 102 and the unified results service 202 can also be implemented as push, poll, and/or on-demand technology.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

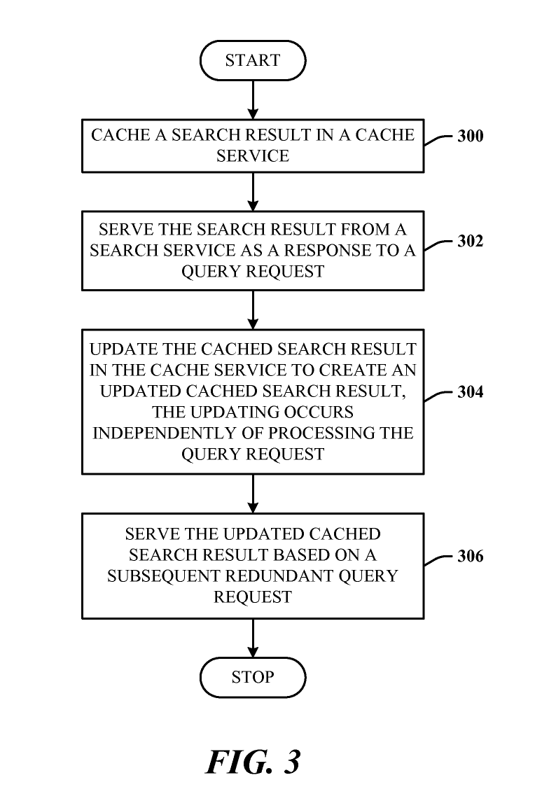

FIG. 3 illustrates a method in accordance with the disclosed architecture. At 300, a search result is cached in a cache service. The cache service is part of a web search component that includes both a search service and a cache service. At 302, the search result is served from the search service as a response to a query request (user supplied search query). The search service and the cache service can be part of a search engine. At 304, the cached search result in the cache service is updated to create an updated cached search result. The updating occurs independently of processing the query request. The updating of the search result in the cache service can be triggered in response to an update process in a unified document store. At 306, the updated cached search result is served based on a subsequent redundant query request.

The method can further comprise storing all information of a document related to the search result in a single unified document store. The unified document store can be a data storage system distributed across many servers. The method can further comprise updating the cached search result on-demand. That is, the cached search result is only updated based on a refresh request sent from the cache service to the unified results component (or service). The method can further comprise receiving realtime document updates to documents of a single unified document store. The method can further comprise sending a cache refresh request from the cache service to a unified results service and receiving the updated cached search result as a cache refresh response back to the cache service.

The method can further comprise storing a document and document version information in the cache service. The method can further comprise sending a refresh request to a search result service. The refresh request specifies document identifiers and document versions comparable to a document related to the search result. The method can further comprise regenerating a search result related to a search document in response to receiving an updated version of the search document, and sending the updated version of the search result to the cache service.

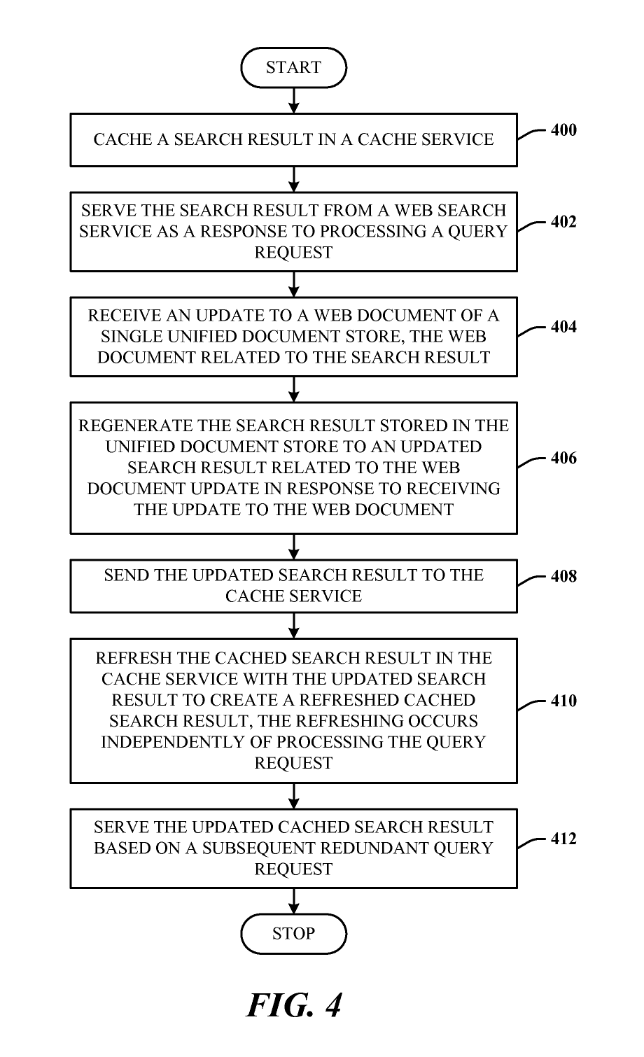

FIG. 4 illustrates an alternative method in accordance with the disclosed architecture. At 400, a search result is cached in a cache service. At 402, the search result is served from a web search service as a response to processing a query request. At 404, an update to a web document of a single unified document store is received. The web document is related to the search result. At 406, the search result stored in the unified document store is regenerated to an updated search result related to the web document update in response to receiving the update to the web document. At 408, the updated search result is sent to the cache service. At 410, the cached search result in the cache service is refreshed with the updated search result to create a refreshed cached search result. The refreshing occurs independently of processing the query request. At 412, the updated cached search result is served based on a subsequent redundant query request.

The method can further comprise serving the search result from the cache service via the web service rather than accessing a web index. The method can further comprise receiving at a search result service, a refresh request from the cache service to refresh the cached search result. The search result service accesses the unified document store based on document and document version information as part of the refresh request, and returns the updated search result to the cache service. The method can further comprise preventing return of any information from a search result service to the cache service in response to no updated search result in the unified document store.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

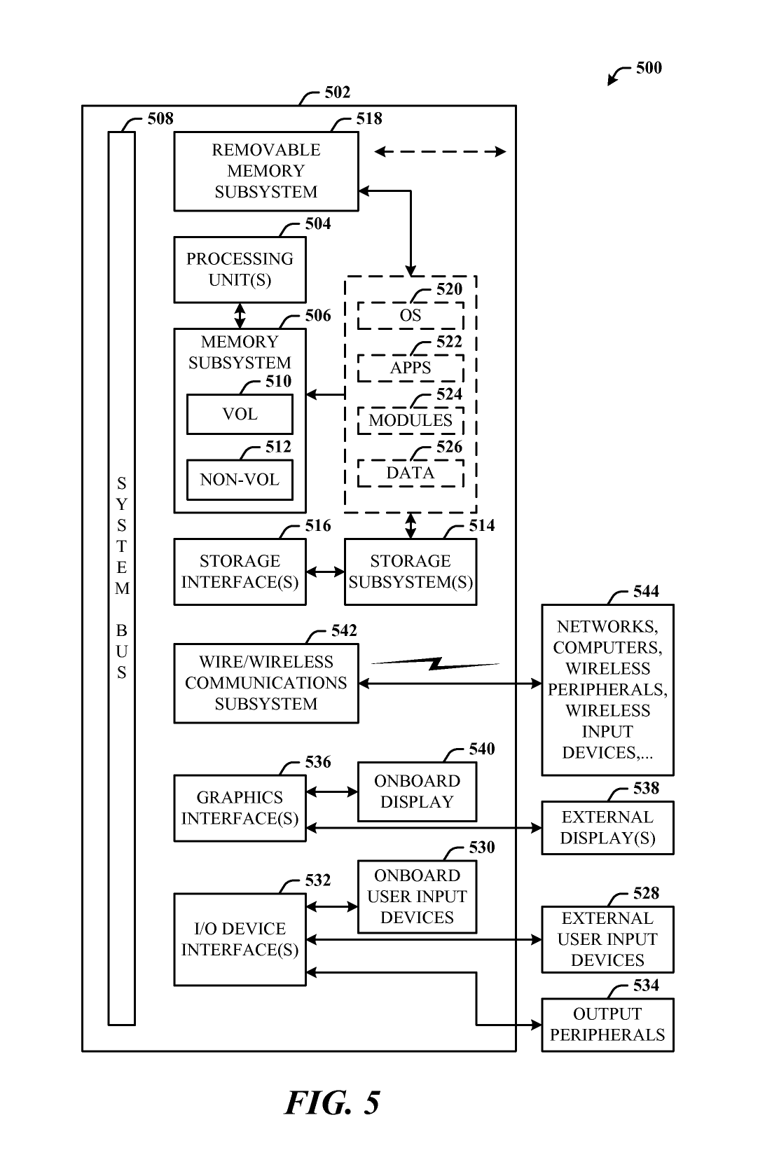

Referring now to FIG. 5, there is illustrated a block diagram of a computing system 500 that executes unified fresh result serving using instant result cache updating in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 500 for implementing various aspects includes the computer 502 having processing unit(s) 504 (also referred to as microprocessor(s) and processor(s)), a computer-readable storage such as a system memory 506, and a system bus 508. The processing unit(s) 504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 502 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 506 can include computer-readable storage (physical storage media) such as a volatile (VOL) memory 510 (e.g., random access memory (RAM)) and non-volatile memory (NON-VOL) 512 (e.g., ROM, EPROM, EEPROM, etc.). A basic input/output system (BIOS) can be stored in the non-volatile memory 512, and includes the basic routines that facilitate the communication of data and signals between components within the computer 502, such as during startup. The volatile memory 510 can also include a high-speed RAM such as static RAM for caching data.

The system bus 508 provides an interface for system components including, but not limited to, the system memory 506 to the processing unit(s) 504. The system bus 508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 502 further includes machine readable storage subsystem(s) 514 and storage interface(s) 516 for interfacing the storage subsystem(s) 514 to the system bus 508 and other desired computer components. The storage subsystem(s) 514 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 516 can include interface technologies such as EIDE, ATA, SATA, and IEEE 1394, for example.

One or more programs and data can be stored in the memory subsystem 506, a machine readable and removable memory subsystem 518 (e.g., flash drive form factor technology), and/or the storage subsystem(s) 514 (e.g., optical, magnetic, solid state), including an operating system 520, one or more application programs 522, other program modules 524, and program data 526.

The operating system 520, one or more application programs 522, other program modules 524, and/or program data 526 can include entities and components of the system 100 of FIG. 1, entities and components of the system 200 of FIG. 2, and the methods represented by the flowcharts of FIGS. 3 and 4, for example.

Generally, programs include routines, methods, data structures, other software components, etc., that perform particular tasks or implement particular abstract data types. All or portions of the operating system 520, applications 522, modules 524, and/or data 526 can also be cached in memory such as the volatile memory 510, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that does not employ propagated signals, can be accessed by the computer 502, and includes volatile and non-volatile internal and/or external media that is removable or non-removable. For the computer 502, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 502, programs, and data using external user input devices 528 such as a keyboard and a mouse, as well as by voice commands facilitated by speech recognition. Other external user input devices 528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 502, programs, and data using onboard user input devices 530 such a touchpad, microphone, keyboard, etc., where the computer 502 is a portable computer, for example.

These and other input devices are connected to the processing unit(s) 504 through input/output (I/O) device interface(s) 532 via the system bus 508, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 532 also facilitate the use of output peripherals 534 such as printers, audio devices, camera devices, and so on, such as a sound card and/or onboard audio processing capability.

One or more graphics interface(s) 536 (also commonly referred to as a graphics processing unit (GPU)) provide graphics and video signals between the computer 502 and external display(s) 538 (e.g., LCD, plasma) and/or onboard displays 540 (e.g., for portable computer). The graphics interface(s) 536 can also be manufactured as part of the computer system board.

The computer 502 can operate in a networked environment (e.g., IP-based) using logical connections via a wired/wireless communications subsystem 542 to one or more networks and/or other computers. The other computers can include workstations, servers, routers, personal computers, microprocessor-based entertainment appliances, peer devices or other common network nodes, and typically include many or all of the elements described relative to the computer 502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 502 connects to the network via a wired/wireless communication subsystem 542 (e.g., a network interface adapter, onboard transceiver subsystem, etc.) to communicate with wired/wireless networks, wired/wireless printers, wired/wireless input devices 544, and so on. The computer 502 can include a modem or other means for establishing communications over the network. In a networked environment, programs and data relative to the computer 502 can be stored in the remote memory/storage device, as is associated with a distributed system. It will be appreciated that the network connections shown are exemplary and other means of establishing a communications link between the computers can be used.

The computer 502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a search component that serves a search result as a query response to a query request, the search component includes a cache service from which the search result is obtained;
a unified results component that stores and services all related search documents and updates the cache service on an as-needed basis; and
a microprocessor that executes computer-executable instructions associated with at least one of the search component or the unified results component.

2. The system of claim 1, wherein the unified results component receives realtime updates to the stored search documents.

3. The system of claim 1, wherein the search component sends a search result refresh request to the unified results component.

4. The system of claim 1, wherein the unified results component sends a cache refresh response to the search component.

5. The system of claim 1, wherein the cache service stores the web document and document version information of the web document.

6. The system of claim 1, wherein the search component returns the search result from the cache service when the search result is in the cache service.

7. The system of claim 1, wherein the cache service sends a refresh request to the unified results component, the refresh request specifies document identifiers and document versions.

8. The system of claim 1, wherein the unified results component regenerates a search result of a search document in response to receiving an updated version of the search document, and sends the updated version of the search document to the cache service.

9. A method, performed by a computer system executing machine-readable instructions, the method comprising acts of:
caching a search result in a cache service;
serving the search result from a search service as a response to a query request;
updating the cached search result in the cache service to create an updated cached search result, the updating occurs independently of processing the query request; and
serving the updated cached search result on a subsequent redundant query request.

10. The method of claim 9, further comprising storing all information of a document related to the search result in a single unified document store.

11. The method of claim 9, further comprising updating the cached search result on-demand.

12. The method of claim 9, further comprising receiving realtime document updates to documents of a single unified document store.

13. The method of claim 9, further comprising sending a cache refresh request from the cache service to a unified results service and receiving the updated cached search result as a cache refresh response back to the cache service.

14. The method of claim 9, further comprising storing a document and document version information in the cache service.

15. The method of claim 9, further comprising sending a refresh request to a search result service, the refresh request specifies document identifiers and document versions comparable to a document related to the search result.

16. The method of claim 9, further comprising regenerating a search result related to a search document in response to receiving an updated version of the search document, and sending the updated version of the search result to the cache service.

17. A method performed by a computer system executing machine-readable instructions, the method comprising acts of:
caching a search result in a cache service;
serving the search result from a web search service as a response to processing a query request;
receiving an update to a web document of a single unified document store, the web document related to the search result;
regenerating the search result stored in the unified document store to an updated search result related to the web document update in response to receiving the update to the web document;
sending the updated search result to the cache service;
refreshing the cached search result in the cache service with the updated search result to create a refreshed cached search result, the refreshing occurs independently of processing the query request; and
serving the updated cached search result on a subsequent redundant query request.

18. The method of claim 17, further comprising serving the search result from the cache service via the web service rather than accessing a web index.

19. The method of claim 17, further comprising receiving at a search result service, a refresh request from the cache service to refresh the cached search result, the search result service accessing the unified document store based on document and document version information as part of the refresh request, and returning the updated search result to the cache service.

20. The method of claim 17, further comprising preventing return of any information from a search result service to the cache service in response to no updated search result in the unified document store.
